(19) United States
(12) Patent Application Publication
(10) Pub. No.: US 2010/0224600 A1
(43) Pub. Date: Sep. 9, 2010

(54) TWO-STEP WELDING PROCESS

(76) Inventors: Reiner Anton, Duisburg (DE); Birgit Grüger, Dortmund (DE); Brigitte Heinecke, Mulheim an der Ruhr (DE); Dirk Martin Seeger, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/716,465

(22) Filed: Mar. 3, 2010

(30) Foreign Application Priority Data
Mar. 4, 2009 (EP) 09003104.8

(51) Int. Cl. B23K 15/00; B23K 31/02; B23K 26/20

(52) U.S. Cl. 219/121.14; 228/256; 219/121.64; 228/225

(57) ABSTRACT

A welding process is provided. The welding process includes two steps. First, the welding material is applied over a large area of the substrate in the region without melting or partially melting the welding material. Then, a welding device is used to melt the applied welding material. In addition the welding material may be applied in two applications where the second application of the welding material is applied over a large area of the first application of molten and solidified welding material. Then, the second application of the welding material is melted.

### CROSS REFERENCE TO RELATED APPLICATIONS

This application claims priority of European Patent Office application No. 09003104.8 EP filed Mar. 4, 2009, which is incorporated by reference herein in its entirety.

### FIELD OF INVENTION

The invention relates to a welding process according to the preamble of the claims.

### BACKGROUND OF INVENTION

Welding processes are used for joining components to one another or for material or wall thickening.

This is the case, for example, with gas turbine parts which are subject to operational stresses, such as turbine blades or vanes. In this case, erosion or corrosion reduces the wall thickness of the cast part, and this thickness has to be re-established. However, it is often very complex to produce a thickening using the known welding processes.

### SUMMARY OF INVENTION

It is therefore an object of the invention to simplify this welding process.

The object is achieved by a welding process as claimed in the claims.

The dependent claims list further advantageous measures which can be combined arbitrarily with one another in order to obtain further advantages.

### BRIEF DESCRIPTION OF THE DRAWINGS

In the drawings:

FIGS. 1, 2, 3, 4 show different stages of the welding process,

FIGS. 5, 6 show possible ways of building up a contour,

FIG. 7 shows a gas turbine,

FIG. 8 shows a turbine blade or vane,

FIG. 9 shows a combustion chamber, and

FIG. 10 shows a list of superalloys.

The description of the figures represents merely exemplary embodiments of the invention.

### DETAILED DESCRIPTION OF INVENTION

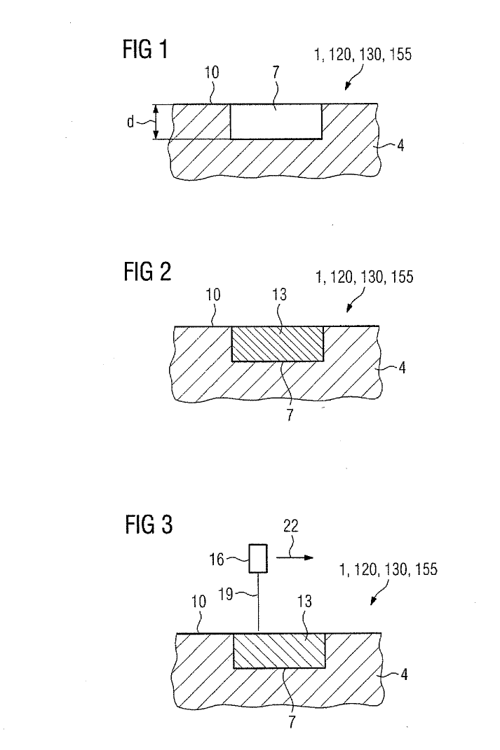

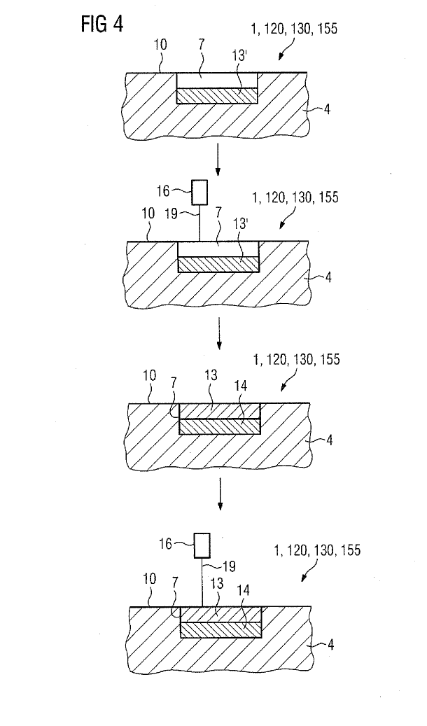

FIG. 1 shows a component 1, 120, 130, 155 with a substrate 4 having an outer, accessible surface 10, one point of this substrate 4 having a crack or a thinned wall section which is to be filled again or a contour being built up on said substrate 4 (FIGS. 5, 6). This region is denoted by 7 or 7 denotes a correspondingly previously prepared point which, in particular, is deeper and preferably excavated. The region 7 therefore also represents a depression or an excavation.

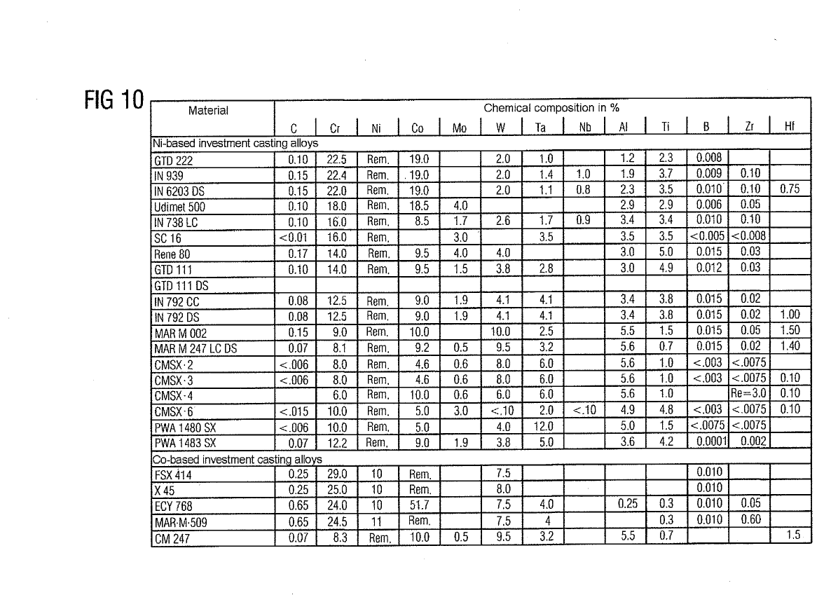

The substrate 4 is preferably a nickel-based or cobalt-based superalloy according to FIG. 10, in particular in the case of turbine blades or vanes 120, 130.

In a first step, the material to be welded (welding material) 13 is applied in full over a large area into the depression 7 or onto the region 7 (FIG. 2).

The welding material 13 can be introduced in the form of powder or else in the form of sheets. It is also conceivable to apply the welding material in the form of a film, wherein the powder is pressed together with or without a binder, preferably without a binder. Presintered forms can also be used as the welding material 13, 13′.

A non-thermal or thermal spraying process may also be used to apply welding material 13 in/to the region 7.

Other types of introduction or application are possible.

The quantity of welding material 13 is preferably such that, after the melting and the solidification of the welding material 13, the preceding depression 7 is correspondingly completely filled to the height d (depth of the depression).

It is only in the second step (FIG. 3) that use is made of a welding device 16, preferably a plasma torch, a laser 16 or an electrode beam source 16, which melts the welding material 13 such that said material 13 is joined to the substrate 4. It is preferable that the welding device 16 has to be switched on only after the welding material 13, 13′ has been applied.

The welding device 16, the laser 16 or the electrode beam source 16 is preferably moved over the welding material 13 in a movement direction 22, or the substrate 4 and the laser 16 are moved in relation to one another, such that the welding beam 19 or laser beam 19 covers at least the entire outer surface of the welding material 13.

It is also possible to produce a plurality of parallel welding tracks, i.e. the region 7 to be welded is preferably covered in a meandering fashion by the welding beam 19 of the welding device 16. The welding tracks produced in this way may overlap one another.

The melting of the welding material 13 does not involve the supply of further material.

It is also possible to repeat the process, i.e. in order to achieve the height d of the welding material 13′, 13 in two stages (d/2+d/2) (FIG. 4) or a plurality of stages. Here, fresh welding material 13 is applied to an already welded region 14 (=molten and solidified welding material 13′) and allowed to melt and solidify.

The melting of the welding material 13, 13′ does not involve the supply of further material.

The process can also be used to build up contours 13″, 13′″, 13″″ on a surface 10 of a component.

This can take place at an undamaged point of the substrate 4 (FIG. 5) or where another welding 13, 13′, 14 has already taken place (FIG. 6). The contours 13″, 13′″, 13″″ can be arranged on or around the welding 13, 13′, 14. Contours rise up considerably from the surrounding surface 10 on the substrate 4. By way of example, these are sealing points (fins) or a crest of a blade or vane tip.

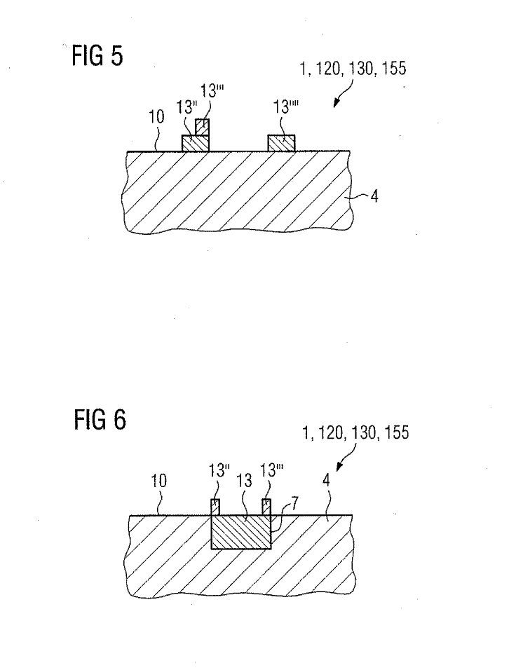

FIG. 7 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

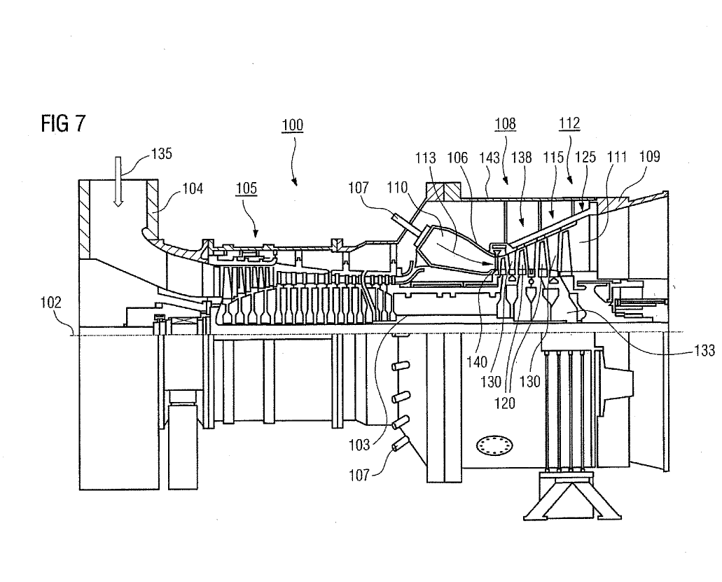

FIG. 8 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably foams transverse and longitudinal grain boundaries, which negate the favorable properties of the directionally solidified or single-crystal component.

Where the text refers in general tunas to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

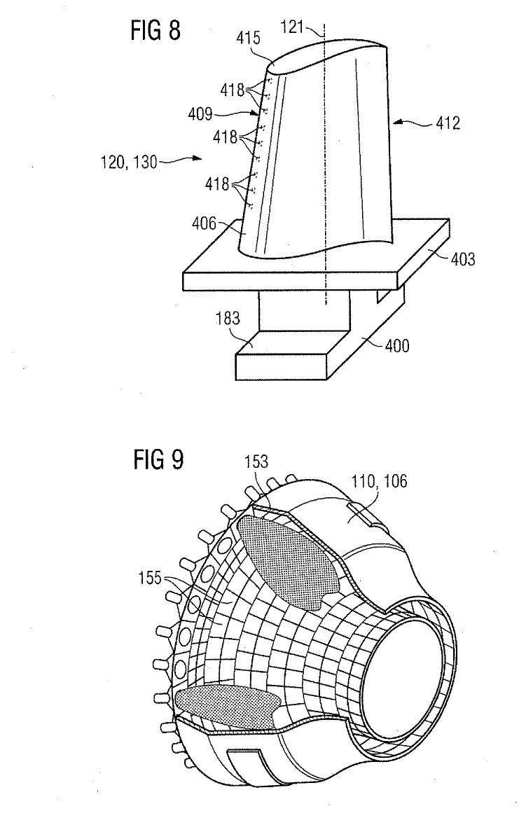

FIG. 9 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from turbine blades or vanes 120, 130 and heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 and heat shield elements 155, after which the turbine blades or vanes 120, 130 or the heat shield elements 155 can be reused.

1.-10. (canceled)

11. A method for welding a region of a substrate of a component, comprising:
applying a welding material over a large area of the substrate in the region without melting or partially melting the welding material; and
melting the applied welding material by a welding device.

12. The method as claimed in claim 11, wherein the welding material comprises a powder.

13. The method as claimed in claim 11, wherein the welding material is applied in a form of a film.

14. The method as claimed in claim 11, wherein the welding material is melted by a laser.

15. The method as claimed in claim 12, wherein the welding material is melted by the laser.

16. The method as claimed in claim 13, wherein the welding material is melted by the laser.

17. The method as claimed in claim 11, wherein the welding material is melted by an electron beam source.

18. The method as claimed in claim 12, wherein the welding material is melted by the electron beam source.

19. The method as claimed in claim 13, wherein the welding material is melted by the electron beam source.

20. The method as claimed in claim 11, wherein the welding device or a welding beam and the welding material perform a relative movement in relation to one another.

21. The method as claimed in claim 14, wherein the welding device or the welding beam and the welding material perform a relative movement in relation to one another.

22. The method as claimed in claim 17, wherein the welding device or the welding beam and the welding material perform a relative movement in relation to one another.

23. The method as claimed in claim 11, wherein the melting of the welding material does not involve supplying a further welding material.

24. The method as claimed in claim 11, further comprising applying a second application of the welding material over a large area of the first application of molten and solidified welding material, and
wherein the second application of the welding material is then melted.

25. The method as claimed in claim 11, wherein the welding material is applied only once for complete processing of the region.

26. The method as claimed in claim 11, wherein a plurality of contours are produced on a surface of the substrate.

27. The method as claimed in claim 11, wherein the substrate is a nickel-based superalloy.

28. The method as claimed in claim 11, wherein the substrate is a cobalt-base superalloy.
